(19) United States
(12) Patent Application Publication
(10) Pub. No.: US 2023/0383489 A1
(43) Pub. Date: Nov. 30, 2023

(54) Layout Method of Large-flux Algae Control Wells Based on Sluice-pump Hub Area

(71) Applicant: NANJING HYDRAULIC RESEARCH INSTITUTE, Nanjing City (CN)

(72) Inventors: Ziwu Fan, Nanjing City (CN); Chen Xie, Nanjing City (CN); Jingxiu Wu, Nanjing City (CN); Qiupeng Cai, Nanjing City (CN); Zhenkun Ma, Nanjing City (CN); Lin Gan, Nanjing City (CN); Yifan Su, Nanjing City (CN); Wenhan Zhu, Nanjing City (CN); Xiangzhe Xu, Nanjing City (CN); Hangyu Hu, Nanjing City (CN)

(21) Appl. No.: 18/448,719

(22) Filed: Aug. 11, 2023

(30) Foreign Application Priority Data
Jan. 10, 2023 (CN) 2023100308558

(51) Int. Cl. E02B 8/02

(52) U.S. Cl. CPC E02B 8/023

(57) ABSTRACT

A layout method of large-flux algae control wells based on a sluice-pump hub area includes: defining positions of a sluice-pump hub and a river diversion channel as a sluice-pump hub area, arranging at least two sets of pumping station units at the water outlet end of the river diversion channel, using a water flow model to guide streamline and flow velocity distribution of water flow in the river diversion channel, and determining whether it is necessary to adopt rectification measures based on water flow streamline and flow velocity distribution; and obtaining hydraulic characteristic values of the pumping station units, determining whether the currently arranged algae control wells and the adopted rectifying measures simultaneously meet the algae control requirements and subsequent running requirements of the pumping station units based on the hydraulic characteristic values.

### TECHNICAL FIELD

The disclosure pertains to the technical field of preventing and controlling blue-green algae in the river network, and specifically pertains to a layout method of large-flux algae control wells based on a sluice-pump hub area.

### BACKGROUND

Water quality of a river course and a regional water environment image are seriously affected by the backflow and large-area accumulation of blue-green algae. In order to prevent the impact of blue-green algae on the water quality of the river course and the water ecological environment, it is necessary to enhance and improve the regional water environment image. However, algae control wells were not applied in the river course yet for the purpose of improving the water quality in a river diversion channel, which is generally treated manually.

When algae control demands increase, a relatively large quantity of algae control wells needs to be arranged in a sluice-pump hub area to meet the demand for large-flux algae control, however, it has been found through practice that: when the algae control well engineering is adjacent to a river pumping station of an outer pond, the algae control well is located in the river diversion channel of the pumping station, the flow regime of water outflow of the algae control well directly affect the operation state of the pumping station unit, such as water flow stability and water outflow.

### SUMMARY

In order to overcome the above technical problems in the background art, the disclosure provides a layout method of large-flux algae control wells based on a sluice-pump hub area.

The disclosure adopts the following technical solution: a layout method of large-flux algae control wells based on a sluice-pump hub area, at least including the following steps:

defining positions of a sluice-pump hub and a river diversion channel as a sluice-pump hub area, and arranging at least two sets of pumping station units side by side at the water outlet end of the river diversion channel, where the pumping station units are communicated with a water inlet tank; a retaining wall is arranged in the river diversion channel, and a plurality of algae control wells are arranged at the retaining wall according to predetermined gaps;

creating a water flow model, using the water flow model to guide streamline and flow velocity distribution of water flow in a river diversion channel, and determining whether it is necessary to adopt rectification measures based on the streamline and flow velocity distribution of the water flow, so that the flow velocity and the flow velocity distribution of water flow in the river diversion channel additionally provided with algae control wells are improved; and

obtaining hydraulic characteristic values of the pumping station units, determining whether the currently arranged algae control wells and the adopted rectifying measures simultaneously meet the algae control requirements and subsequent running requirements of the pumping station units based on the hydraulic characteristic values.

The method further includes the following steps:

performing grid division on the river diversion channel, algae control wells, and pumping station units of the water flow model, and performing grid independence verification to obtain the optimal number of grids.

The rectification measures further include: adopting one or more of the following ones: adjusting the form of the retaining wall, setting up a bottom sill with a predetermined depth, adding guiding walls, or adding one or more of cut banks.

The creation process of the water flow model is as follows:

the formula for the water flow streamline equation is given by:

$$\frac{\partial ρ {u}_{t}}{\partial t} + \frac{\partial }{\partial \text{?}} ( ρ {u}_{t} {u}_{j} ) = - \frac{\partial p}{\partial \text{?}} + \frac{\partial }{\partial \text{?}} [ μ ( \frac{\partial \text{?}}{\partial \text{?}} + \frac{\partial \text{?}}{\partial \text{?}} ) ] + {S}_{t} ;$$

$$\text{?} \text{indicates text missing or illegible when filed}$$

in the formula, i and j are coordinate axis numbers; uₜ, uⱼ are flow velocity vectors in directions of the coordinate axes numbered i and j, respectively; t is the time; p is the density of the water flow fluid; xᵢ and xⱼ are the coordinate axis numbered i and j; μ is the dynamic viscosity of the water flow fluid; Sᵢ is a momentum source item; and p is the water flow fluid pressure;

the formula for the flow velocity distribution equation is given by:

$$\frac{\partial ( ρ k )}{\partial t} + \frac{\partial ( ρ {ku}_{j} )}{\partial {x}_{j}} = \frac{\partial }{\partial {x}_{j}} [ ( μ + \frac{\text{?}}{{σ}_{k}} ) \frac{\partial k}{\partial {x}_{j}} ] + ρ ( {Q}_{k} - ε )$$

$$\frac{\partial ( ρε )}{\partial t} + \frac{\partial ( ρε {u}_{j} )}{\partial {x}_{j}} = \frac{\partial }{\partial {x}_{j}} [ ( μ + \frac{{μ}_{t}}{{σ}_{ε}} ) \frac{\partial ε}{\partial {x}_{j}} ] + ρ \frac{ε}{k} ( {C}_{1} {P}_{k} - {C}_{2} ε )$$

$$\text{?} \text{indicates text missing or illegible when filed}$$

in the formula, k is the turbulent kinetic energy, ε is the dissipation rate of the turbulent kinetic energy, C₁ and C₂ are model constants, σₖ and σ_{ε}, are turbulent Prandtl numbers of k and ε, respectively, Qₖ represent the generation of turbulent kinetic energy caused by an average flow velocity gradient, and Pₖ, represents turbulent kinetic energy generated by buoyancy;

the streamline diagram and the flow velocity distribution diagram of the water flow in a river course are simulated based on the streamline equation and the flow velocity distribution equation of the water flow, and the average flow velocity and flow velocity distribution of the water flow in the river course are analyzed based on the streamline diagram of the water flow and the flow velocity distribution diagram;

establishing a constraint range for the average flow velocity: [vₘᵢₙ, vₘₐₓ] constraint conditions on the flow velocity distribution: uniformity of distribution, where, vₘᵢₙ is the minimum value allowed by a given average flow velocity, and vₘₐₓ is the maximum value allowed by a given average flow velocity; and

when the average flow velocity obtained through analysis fails to fall within the constraint range and/or the flow velocity distribution fails to meet the constraint conditions, rectification measures need to be adopted.

The hydraulic characteristic values at least include: the flow velocity distribution uniformity and the velocity weighted average angle at the characteristic section of the pumping station units;

the flow velocity distribution uniformity is obtained by the following formula:

$${\overline{V}}_{u} = [ 1 - \frac{1}{\overline{{u}_{a}}} \sqrt{\frac{{Σ ( {u}_{ah} - \overline{{u}_{a}} )}^{2}}{m}} ] ⨯ 100 \% ;$$

the velocity weighted average angle is obtained by the following formula:

$$\overline{θ} = \frac{Σ {u}_{ah} [ 90 ° - arc tan \frac{{u}_{th}}{{u}_{ah}} ]}{Σ {u}_{at}} ;$$

in the formula, h is the number of the pumping station units, uₐₕ is the axial water flow velocity of the pumping station unit numbered h, uₜₕ is the transversal water flow velocity of the pumping station unit numbered h, and u̅ₐ̅ represents the average axial water flow velocity of h pumping station units;

the velocity distribution uniformity threshold V̅ᵤ̅ ′ and the velocity weighted average angle threshold θ̅ are preset, and when the V̅ᵤ̅ <V̅ᵤ̅ ′ and/or θ̅<θ̅ ′ through calculation, it is necessary to adopt the rectification measures.

The method for intercepting a characteristic section is as follows:

selecting an inlet of the water inlet flow channel of each pumping station unit, and intercepting a vertical section obtained by the outlet of the water inlet flow channel in a vertical plane to obtain a characteristic section.

The process of obtaining the optimal number of grids is as follows:

subdividing grids of the river diversion channel, algae control wells, and pumping station units, performing local encryption processing on areas with complex structures, improving the quality of local grids by adjusting control points on the grids and adding topology layers, and controlling the dimensionless value within 100;

the total hydraulic loss is used as a basis to measure the influence of the number of grids on numerical calculation result, and the total hydraulic loss is calculated by the following formula:

$${H}_{f} = \frac{( {P}_{i n} - {P}_{out} )}{ρ g} ;$$

in the formula, H_{f} is the total hydraulic loss of the whole flow channel; Pᵢₙ and Pₒᵤₜ are the total pressure of the inlet and outlet of the inlet pool, respectively, and g is gravity acceleration;

the analysis of grid independence indicates that the variation of hydraulic loss is small when the total number of grids is 12 million, and the grid quality reaches more than 0.3, meeting the numerical calculation requirements.

The bottom sill includes: one or more of a forebay bottom sill and a bottom sill in the river diversion channel.

The retaining wall has a first wall surface and a second wall surface, the first wall surface and the second wall surface are perpendicular to each other, and the algae control wells are arranged in the first wall surface and the second wall surface at a predetermined interval.

The retaining wall has an arc-shaped wall surface and a second wall surface, and the arc-shaped wall surfaces are arranged opposite to the sluice-pump hub; and

the algae control wells are arranged in the arc-shaped wall surface at a predetermined interval.

Beneficial effects of the disclosure: in the disclosure, the large-flux algae control is achieved by arranging a plurality of algae control wells in the river course, so that the algae control requirements and algae control efficiency are satisfied, if needed.

At the same time, the plurality of algae control wells are arranged in a reasonable way by providing the water flow model, the hydraulic characteristic value of the pumping station units and the corresponding rectification measures, so that the problem of reduction in flow rate, water level and flow regime due to the arrangement of the algae control wells is solved, and increasing demands of algae control are satisfied without affecting basic functions of the pumping station units.

### BRIEF DESCRIPTION OF THE DRAWINGS

FIG. 1 is a measurement diagram for the number of grids in Embodiment 1.

FIG. 2 is a layout of algae control wells in Embodiment 2.

FIG. 3 is a water flow streamline diagram of Embodiment 2.

FIG. 4 is a flow velocity distribution diagram of Embodiment 2.

FIG. 5 is a layout of algae control wells in Embodiment 3.

FIG. 6 is a water flow streamline diagram of Embodiment 3.

FIG. 7 is a flow velocity distribution diagram of Embodiment 3.

FIG. 8 is a layout of algae control wells in Embodiment 4.

FIG. 9 is a water flow streamline diagram of Embodiment 4.

FIG. 10 is a flow velocity distribution diagram of Embodiment 4.

FIG. 11 is a layout of algae control wells in Embodiment 5.

FIG. 12 is a water flow streamline diagram of Embodiment 5.

FIG. 13 is a flow velocity distribution diagram of Embodiment 5.

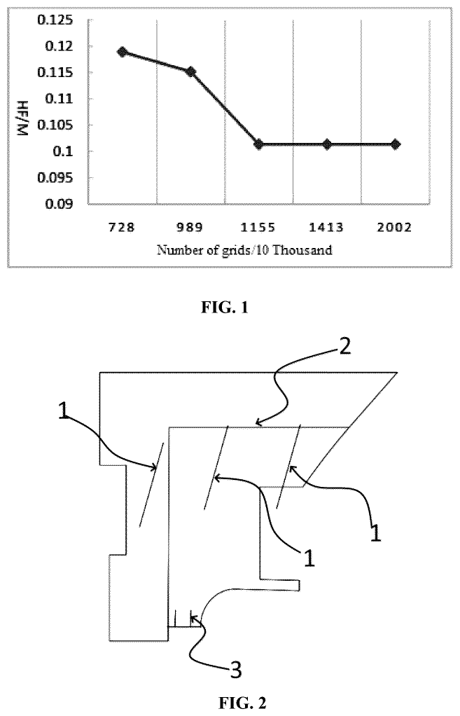

Reference numbers in FIGS. 1-3: algae control well 1, retaining wall 2, pumping station unit 3, guide wall 4, forebay bottom sill 5, and bottom sill in the river diversion channel 6.

### DESCRIPTION OF THE EMBODIMENTS

### Embodiment 1

In order to solve the above technical problems, the disclosure provides a layout method of large-flux algae control wells based on a sluice-pump hub area, which at least includes the following steps:

Step 1: define positions of a sluice-pump hub and a river diversion channel as a sluice-pump hub area, and arrange at least two sets of pumping station units side by side at the water outlet end of the river diversion channel, where the pumping station units are communicated with a water inlet tank; a retaining wall is arranged in the river diversion channel, and a plurality of algae control wells are arranged at the retaining wall according to predetermined gaps; in this embodiment, three sets of pumping station units are arranged. In this embodiment, the retaining wall has two forms, one of which has two wall surfaces with right angles, the other form has two arc-shaped wall surfaces, where the arc-shaped wall surfaces are arranged opposite to the sluice-pump hub.

Step 2: create a water flow model, use the water flow model to guide streamline and flow velocity distribution of water flow in a river diversion channel, and determine whether it is necessary to adopt rectification measures based on the water flow streamline and flow velocity distribution, so that the flow velocity and the flow velocity distribution of the water flow in the river diversion channel additionally provided with algae control wells are improved; and the selection of the form of the retaining wall is also one of the rectification measures in this embodiment. Further, rectification measures also include: adopting one or more of the following ones: setting up a bottom sill with a predetermined depth, adding guiding walls, or adding one or more of cut banks.

Step 3: obtain hydraulic characteristic values of the pumping station units, determine whether the currently arranged algae control wells and the adopted rectifying measures simultaneously meet the algae control requirements and subsequent running requirements of the pumping station units based on the hydraulic characteristic values, that is, when it is found through analysis that after the algae control wells are added, the water flow quality of the river diversion channel becomes worsen, one or more of the rectification measures (adjusting the form of the retaining wall, setting up the bottom sill with a predetermined depth, adding guiding walls, or adding cut banks) can be adopted), so as to enable the water flow in the river diversion channel after rectification to be restored to the state before the algae control wells are added, and simultaneously, to meet dual requirements of algae control and drainage.

It can be seen from Steps 1-3, this embodiment determines whether addition of the algae control wells in the existing river diversion channel will affect normal work of the river diversion channel by analyzing the water flow streamline and the flow velocity distribution in the river diversion channel and calculating the hydraulic characteristic values of the pumping station units, and then selects the corresponding rectification measures, if needed, based on the aforesaid analysis.

In a further embodiment, the creation process of the water flow model is as follows:

the formula for the water flow streamline equation is given by:

$$\frac{\partial ρ {u}_{i}}{\partial t} + \frac{\partial }{\partial {x}_{j}} ( ρ {u}_{i} {u}_{j} ) = - \frac{\partial p}{\partial {x}_{i}} + \frac{\partial }{\partial {x}_{j}} [ μ ( \frac{\partial {u}_{i}}{\partial {x}_{j}} + \frac{\partial {u}_{j}}{\partial {x}_{i}} ) ] + {S}_{t} ;$$

in the formula, i and j are coordinate axis numbers; uᵢ, uⱼ rare flow velocity vectors in directions of the coordinate axes numbered i and j, respectively; t is the time; p is the density of the water flow fluid; xᵢ and xⱼ are the coordinate axis numbered i and j; μ is the dynamic viscosity of the water flow fluid; Sᵢ is a momentum source item; and p is the water flow fluid pressure;

the formula for the flow velocity distribution equation is given by:

$$\frac{\partial ( ρ k )}{\partial t} + \frac{\partial ( ρ {ku}_{j} )}{\partial {x}_{j}} = \frac{\partial }{\partial {x}_{j}} [ ( μ + \frac{{μ}_{t}}{{σ}_{k}} ) \frac{\partial k}{\partial {x}_{j}} ] + ρ ( {Q}_{k} - ε )$$

$$\frac{\partial ( ρ ε )}{\partial t} + \frac{\partial ( ρ ε {u}_{j} )}{\partial {x}_{j}} = \frac{\partial }{\partial {x}_{j}} [ ( μ + \frac{{μ}_{t}}{{σ}_{ε}} ) \frac{\partial ε}{\partial {x}_{j}} ] + ρ \frac{ε}{k} ( {C}_{1} {P}_{k} - {C}_{2} ε )$$

in the formula, k is the turbulent kinetic energy, ε is the dissipation rate of the turbulent kinetic energy, C₁ and C₂ are model constants, σₖ and σ_{ε} are turbulent Prandtl numbers of k and ε, respectively, Qₖ represent the generation of turbulent kinetic energy caused by an average flow velocity gradient, and Pₖ represents turbulent kinetic energy generated by buoyancy;

the streamline diagram and the flow velocity distribution diagram of the water flow in a river course are simulated based on the streamline equation and the flow velocity distribution equation of the water flow, and the average flow velocity and flow velocity distribution of the water flow in the river course are analyzed based on the streamline diagram of the water flow and the flow velocity distribution diagram;

establish a constraint range for the average flow velocity: [vₘᵢₙ, vₘₐₓ], constraint conditions on the flow velocity distribution: uniformity of distribution, where, vₘᵢₙ is the minimum value allowed by a given average flow velocity, and vₘₐₓ is the maximum value allowed by a given average flow velocity.

It should be noted that the setting of the minimum value is to guarantee normal demands of the water flow in the river diversion channel, the setting of the maximum value and the uniformity are to guarantee that the algae control wells have enough time and processing capacity for algae control treatment, and to guarantee subsequent normal operation of the pumping station units without affecting normal navigation, and to avoid large water flow or uniform water flow distribution that are not conducive to the blue algae precipitation and subsequent operation of the pumping station units.

When the average flow velocity obtained through analysis fails to fall within the constraint range and/or the flow velocity distribution fails to meet the constraint conditions, rectification measures need to be adopted. Further rectification measures include: adopting one or more of the following ones: adjusting the form of the retaining wall, setting up a bottom sill with a predetermined depth, adding guiding walls, or adding one or more of cut banks.

The hydraulic characteristic values in Step 3 at least include: the flow velocity distribution uniformity and the velocity weighted average angle at the characteristic section of the pumping station units;

the flow velocity distribution uniformity is obtained by the following formula:

$${\overline{V}}_{u} = [ 1 - \frac{1}{\overline{{u}_{a}}} \sqrt{\frac{{Σ ( {u}_{ah} - \overline{{u}_{a}} )}^{2}}{m}} ] ⨯ 100 \% ;$$

the velocity weighted average angle is obtained by the following formula:

$$\overline{θ} = \frac{Σ {u}_{ah} [ 90 ° - arc tan \frac{{u}_{th}}{{u}_{ah}} ]}{Σ {u}_{at}} ;$$

in the formula, h is the number of the pumping station units, uₐₕ is the axial water flow velocity of the pumping station unit numbered h, uₜₕ is the transversal water flow velocity of the pumping station unit numbered h, and u̅ₐ̅ represents the average axial water flow velocity of h pumping station units;

the velocity distribution uniformity threshold V̅ᵤ̅ ′ and the velocity weighted average angle threshold θ̅ are preset, and when the V̅ᵤ̅<V̅ᵤ̅ ′ and/or θ̅<θ̅ ′ through calculation, it is necessary to adopt the rectification measures.

When the determination is made, only when each hydraulic characteristic value of each set of the pumping station units should meet the requirements, the current layout method of the algae control wells can guarantee basic functions and basic performance of each set of the pumping station units, such as the stability and flux of the water outflow, while realizing the large-flux algae control.

Considering that the water flow model is a model for different areas of the river diversion channel, algae control wells, and pumping station units, and the structural complexity of each area is different. Therefore, in order to increase the simulation accuracy and reduce the error, this embodiment further includes: perform grid division on the river diversion channel, algae control wells, and pumping station units of the water flow model, and perform grid independence verification to obtain the optimal number of grids.

Concrete steps are as follows: subdivide grids of the river diversion channel, algae control wells, and pumping station units, perform local encryption processing on areas with complex structures, improve the quality of local grids by adjusting control points on the grids and adding topology layers, and control the dimensionless value within 100;

the total hydraulic loss is used as a basis to measure the influence of the number of grids on numerical calculation result, and the total hydraulic loss is calculated by the following formula:

$${H}_{f} = \frac{( {P}_{i n} - {P}_{out} )}{ρ g} ;$$

in the formula, H_{f} is the total hydraulic loss of the whole flow channel, Pᵢₙ and Pₒᵤₜ are the total pressure of the inlet and outlet of the inlet pool, respectively, and g is gravity acceleration;

the analysis of grid independence indicates that the variation of hydraulic loss is small when the total number of grids is 12 million, and the grid quality reaches more than 0.3, as shown in FIG. 1, meeting the numerical calculation requirements.

### Embodiment 2

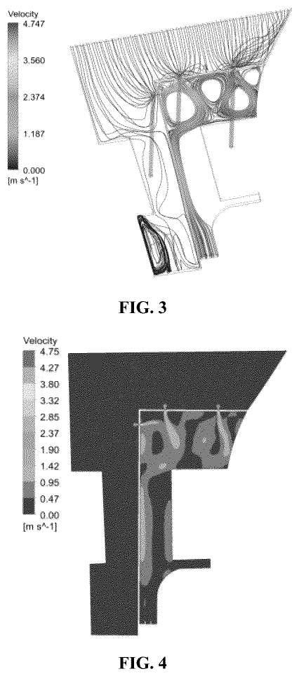

On the basis of the layout method of large-flux algae control wells based on a sluice-pump hub area according to Embodiment 1, this embodiment preferably selects the first form of the retaining wall, that is, the retaining wall has a first wall surface and a second wall surface, and the first wall surface and the second wall surface are perpendicular to each other. The layout of the three algae control wells obtained through the analysis of the water flow model should be as shown in FIG. 2, that is, the algae control wells are arranged in the first wall surface and the second wall surface at a predetermined interval. Based on this, the water flow model is used to obtain the water flow streamline diagram and flow velocity distribution diagram of this embodiment, as shown in FIG. 3 and FIG. 4, respectively. When no rectification measure is adopted, the flow regime on the water outlet side is extremely turbulent due to the lateral water outlet at a larger angle, and the water structure itself has an obvious secondary flow structure, especially in a diffusion section of the river course, the flow velocity difference at the two sides of the river bed is large, the momentum is uneven, resulting in vortexes at a larger scale, the maximum flow velocity of the vortexes can reach 1.3 m/s (greater than vₘₐₓ), and long-term operation can make the river bed severely scoured. Therefore, the problem cannot be effectively solved, and certain rectification measures are thus needed.

Therefore, the rectification measures adopted in this embodiment includes at least one or more of the following ones: changing the form of the retaining wall, setting up a bottom sill with a predetermined depth, adding guiding walls, or adding one or more of cut banks.

The bottom sill includes: one or more of a forebay bottom sill and a bottom sill in the river diversion channel. Further, the forebay bottom sill is the bottom sill with a predetermined depth arranged close to the sluice-pump hub and perpendicular to the water flow direction. Correspondingly, the bottom sill in the river diversion channel is a bottom sill with a predetermined depth arranged close to the algae control wells in the river diversion channel and are perpendicular to the water flow direction.

### Embodiment 3

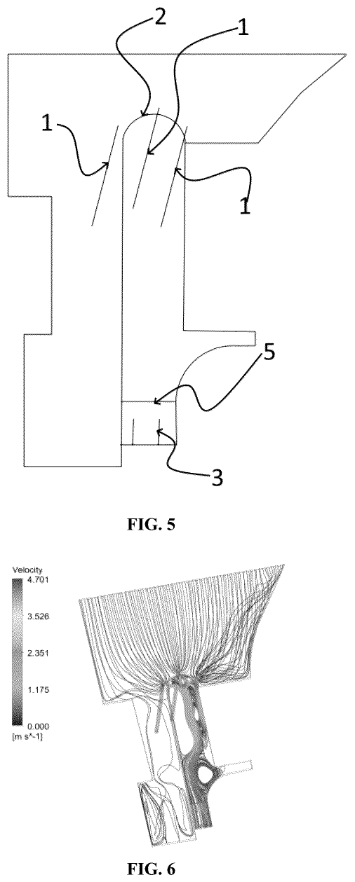

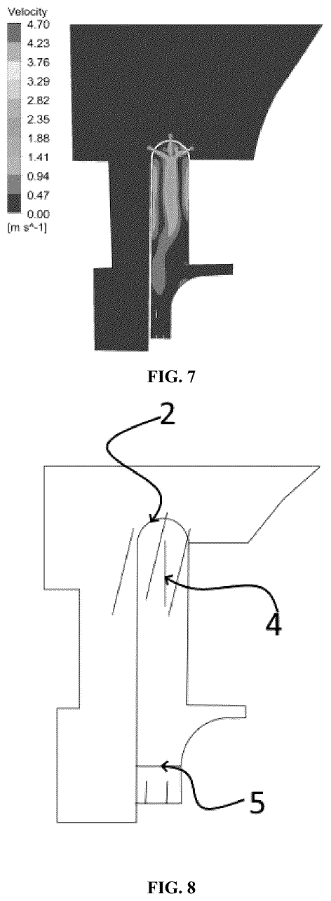

In order to overcome the defects in Embodiment 2, this embodiment not only replaces the form of a retaining wall 2, but also set up a forebay bottom sill 5, based on which the layout of the three algae control wells obtained through the analysis of the water flow model should be as shown in FIG. 5, that is, the algae control wells are arranged in the arc-shaped wall surface at a predetermined interval. Based on this, the water flow model is used to obtain the water flow streamline diagram and flow velocity distribution diagram of this embodiment, as shown in FIG. 6 and FIG. 7, respectively.

The flow regime of the water flow in the layout diagram is observed, and it is found that the arc-shaped wing walls are used to make full use of arrange algae control wells 1, so that the energy of vortexes in the river course is reduced and the scouring of the river course and the bank slope is avoided. However, because the river diversion channel is relatively wide and the forebay pool of the pumping station is relatively narrow, narrow sections of the river course results in a relatively serious bias flow, and relatively large vortexes at the tributary. Although the tumbling energy dissipation through the forebay bottom sill plays a certain role in rectification, and the flow regime has been improved to a certain extent, the flow regime of forebay of the pumping station unit 3 remains poor, a stable vortex belt enters the pumping station unit, which will cause cavitation and vibration of the unit, not good for safe and stable operation of the unit.

### Embodiment 4

In order to overcome the defects in Embodiment 3, this embodiment adds a guide wall on the basis of Embodiment 3, and the guide wall is disposed in the water flow direction, as shown in FIG. 8.

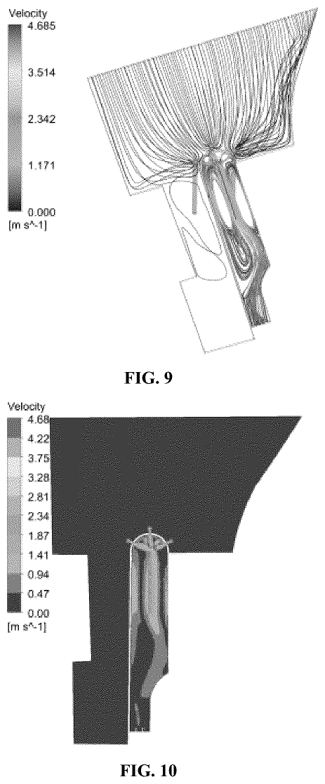

Based on this, the water flow model is used to obtain the water flow streamline diagram and flow velocity distribution diagram of this embodiment, as shown in FIG. 9 and FIG. 10, respectively. The flow regime of the water flow in the layout diagram is observed, and it is found that the vortex problem of the guide wall 4 in the water outlet pool is not solved, the average water flow velocity in the river course at the water outlet side has been reduced a certain extent, but the flow velocity numerical interval remains changed, and the water flow deviation has been improved to a certain extent. Nevertheless, the recovery of water flow at the rear side of the guide wall is poor, the flow velocity distribution is non-uniform, a larger backflow area is formed at the position close to the inlet of the pump station, the flow velocity at the side slope of the river course remains fast, and the side slope is eroded to a certain extent, which is not conducive to the stability of the retaining wall at the position.

### Embodiment 5

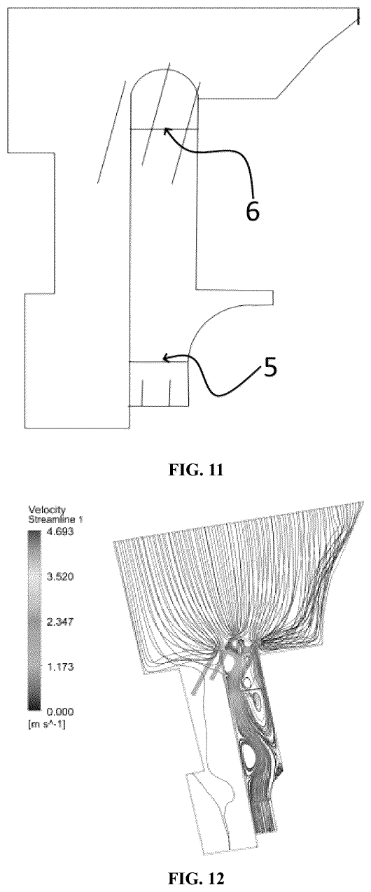

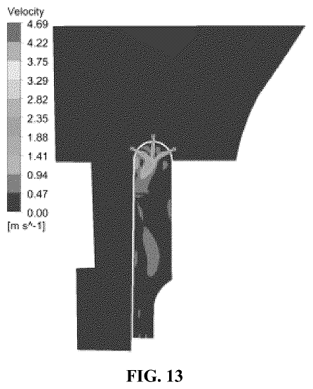

In order to overcome the defects in Embodiment 4, this embodiment further adopts the following rectification measures on the basis of Embodiment 4: a bottom sill 6 with a predetermined depth in the diversion channel and a cut bank, as shown in FIG. 11. Based on this, the water flow model is used to obtain the water flow streamline diagram and flow velocity distribution diagram of this embodiment, as shown in FIG. 12 and FIG. 13, respectively.

The flow regime of the water flow in the layout diagram is observed, and it is found that the flow regime of the water flow in the layout diagram is observed, and it is found that the flow regime has been obviously improved, and the pumping station units can reach an ideal state. At the same time, after the water flow passes through a bottom sill, the turbulent kinetic energy exchange of the water flow through vortex motion and water flow mixing will change the original flow structure of the water flow and eliminate most of the remaining energy of the water flow. The streamline is relatively smooth and straight, and the flow velocity is relatively reasonable. Velocity vectors of each section in the running direction are optimized, and the direction of water flow is adjusted. Although backflow in a small scale is identified, the flow velocity is slow on the whole, the maximum flow velocity of the water flow from the arc-shaped retaining wall to the forebay bottom sill is 0.8 m/s, and the maximum flow velocity of the water flow in the forebay is 0.3 m/s. The water flow in the forebay of the pumping station is relatively stable and straight, no obvious water robbing is found among three pumping station units, and it is expected that ideal design working conditions can be realized.

Based on the findings in Embodiments 2-5, it is found that the rectification measures in Embodiments 3-5 all have the effects of improvement in the river course area, and those in Embodiment 5 proved the optimal effect.

In order to determine whether the rectification measures in Embodiments 2-5 have a certain effect at the position of the pumping station units, Embodiment 6 is performed.

### Embodiment 6

In this embodiment, the hydraulic characteristic values at least include: the flow velocity distribution uniformity and the velocity weighted average angle at the characteristic section of the pumping station units;

the flow velocity distribution uniformity is by the following formula:

$${\overline{V}}_{u} = [ 1 - \frac{1}{\overline{{u}_{a}}} \sqrt{\frac{{Σ ( {u}_{ah} - \overline{{u}_{a}} )}^{2}}{m}} ] ⨯ 100 \% ;$$

the velocity weighted average angle is obtained by the following formula:

$$\overline{θ} = \frac{Σ {u}_{ah} [ 90 ° - arc tan \frac{{u}_{th}}{{u}_{ah}} ]}{Σ {u}_{at}} ;$$

in the formula, h is the number of the pumping station units, uₐₕ station unit numbered h, uₜₕ is the transversal water flow velocity of the pumping station unit numbered h, and u̅ₐ̅ represents the average axial water flow velocity of h pumping station units; and

the velocity distribution uniformity threshold V̅ᵤ̅ ′ and the velocity weighted average angle threshold θ̅ are preset, and when the V̅ᵤ̅<V̅ᵤ̅′ and/or θ̅<θ̅ ′ through calculation, it is necessary to adopt the rectification measures.

That is, each set of the pump stationing unit is analyzed through the flow velocity distribution uniformity and the velocity weighted average angle, and when any of the hydraulic characteristic values of one set of the pumping station units fails to meet the requirements, it means that the entire solution is defective.

Taking Embodiments 2-5 as an example, in order to further compare the differences among all solutions in hydraulic characteristics of the pumping station units, the inlets of the water inlet channel of all pumping station units are selected as characteristic sections to analyze the hydraulic characteristics of all units at the pumping station.

TABLE 1
Normal Flow Velocity Uniformity

| Flow velocity | Embodi- | Embodi- | Embodi- | Embodi- |
|---|---|---|---|---|
| uniformity | ment 2 | ment 3 | ment 4 | ment 5 |
| Algae control well 1 | 81.0% | 85.0% | 78.2% | 89.2% |
| Algae control well 2 | 84.0% | 83.0% | 84.5% | 88.1% |
| Algae control well 3 | 70.0% | 85.8% | 87.0% | 89.6% |

Based on the above formulae and from the comparison of the normal flow velocity uniformity of the characteristic sections of the pumping station units in the four embodiments indicated in Table 1, it can be seen that the average values of the section normal flow velocity uniformity of Embodiment 2, Embodiment 3 and Embodiment 4 are 78.3%, 84.6% and 88.9%, respectively, and Embodiment 5 has the highest flow velocity uniformity of the water inlet section, which is closer to an ideal state, indicating that the flow velocity distribution of the water flow on the characteristic section under this scheme is relatively even and has better hydraulic characteristics. Therefore, the rectification measures in Embodiment 5 have effectively improved the water inlet conditions of each unit at the pumping station, the flow regime in the water inlet pipeline is relatively smoother, and the flow velocity at the water inlet section is relatively uniform, which can meet the requirements of the units under the design working conditions.

TABLE 2
Velocity Weighted Average Angle on Water Inlet Section

| Velocity weighted | Embodi- | Embodi- | Embodi- | Embodi- |
|---|---|---|---|---|
| average angle | ment 2 | ment 3 | ment 4 | ment 5 |
| Algae control well 1 | 73 | 75.1 | 73 | 80 |
| Algae control well 2 | 74 | 75.1 | 71 | 78 |
| Algae control well 3 | 76 | 75.9 | 76 | 79 |

As can be seen from Table 2, the velocity weighted average angle on water inlet section of the three units in Embodiment 2 is relatively small and deviates from the normal direction, where the maximum value is not greater than 76°, the minimum velocity weighted average angle of the 1 #pumping station unit speed is only 73°, vortexes are likely to be generated in the water inlet channel, the flow velocity of water flow is turbulent, the flow direction is complex, the water inlet condition of the device is poor, and the efficiency of the pumping station units is low. The weighted average angles of the three units in Embodiments 3 and 4 increased to some extent, and the water flow direction has been significantly improved, but the overall solution is not yet in an optimal state. In Embodiment 5, the velocity weighted average angle on the water inlet section shows the optimal state on the whole, the velocity weighted average angle is 80°, which is closer to the ideal state of 90°compared with the former two solutions, and the hydraulic characteristics are better, meeting the requirements of a three-dimensional optimization hydraulic design method.

Therefore, Embodiment 5 is superior in terms of the flow regime of the overall flow field, static pressure distribution of the unit device and hydraulic characteristics of the water inlet flow channel.

What is claimed is:

1. A layout method of large-flux algae control wells based on a sluice-pump hub area, at least comprising the following steps:
defining positions of a sluice-pump hub and a river diversion channel as a sluice-pump hub area, and arranging at least two sets of pumping station units side by side at the water outlet end of the river diversion channel, wherein the pumping station units are communicated with a water inlet tank; a retaining wall is arranged in the river diversion channel, and a plurality of algae control wells are arranged at the retaining wall according to predetermined gaps;
creating a water flow model, using the water flow model to guide streamline and flow velocity distribution of water flow in a river diversion channel, and determining whether it is necessary to adopt rectification measures based on the streamline and flow velocity distribution of the water flow, so that the flow velocity and the flow velocity distribution of water flow in the river diversion channel additionally provided with algae control wells are improved; and
obtaining hydraulic characteristic values of the pumping station units, determining whether the currently arranged algae control wells and the adopted rectifying measures simultaneously meet the algae control requirements and subsequent running requirements of the pumping station units based on the hydraulic characteristic values.

2. The layout method of large-flux algae control wells based on a sluice-pump hub area according to claim 1, further comprising the following steps:
performing grid division on the river diversion channel, algae control wells, and
pumping station units of the water flow model, and performing grid independence verification to obtain the optimal number of grids.

3. The layout method of large-flux algae control wells based on a sluice-pump hub area according to claim 1, wherein the rectification measures comprise: adopting one or more of the following ones: adjusting the form of the retaining wall, setting up a bottom sill with a predetermined depth, adding guiding walls, or adding one or more of cut banks.

4. The layout method of large-flux algae control wells based on a sluice-pump hub area according to claim 1, wherein the creation process of the water flow model is as follows:
the formula for the water flow streamline is given by:
$$\frac{\partial ρ {u}_{i}}{\partial t} + \frac{\partial }{\partial {x}_{j}} ( ρ {u}_{i} {u}_{j} ) = - \frac{\partial p}{\partial {x}_{i}} + \frac{\partial }{\partial {x}_{j}} [ μ ( \frac{\partial {u}_{i}}{\partial {x}_{j}} + \frac{\partial {u}_{j}}{\partial {x}_{i}} ) ] + {S}_{t} ;$$
in the formula, i and j are coordinate axis numbers; uᵢ, uⱼ pare flow velocity vectors in directions of the coordinate axes numbered i and j, respectively; t is the time; p is the density of the water flow fluid; xᵢ and xⱼ are the coordinate axis numbered i and j; μ is the dynamic viscosity of the water flow fluid; Sᵢ is a momentum source item; and p is the water flow fluid pressure;
the formula for the flow velocity distribution is given by:
$$\frac{\partial ( ρ k )}{\partial t} + \frac{\partial ( ρ {ku}_{j} )}{\partial {x}_{j}} = \frac{\partial }{\partial {x}_{j}} [ ( μ + \frac{{μ}_{t}}{{σ}_{k}} ) \frac{\partial k}{\partial {x}_{j}} ] + ρ ( {Q}_{k} - ε )$$
$$\frac{\partial ( ρ ε )}{\partial t} + \frac{\partial ( ρ ε {u}_{j} )}{\partial {x}_{j}} = \frac{\partial }{\partial {x}_{j}} [ ( μ + \frac{{μ}_{t}}{{σ}_{ε}} ) \frac{\partial ε}{\partial {x}_{j}} ] + ρ \frac{ε}{k} ( {C}_{1} {P}_{k} - {C}_{2} ε )$$
in the formula, k is the turbulent kinetic energy, ε is the dissipation rate of the turbulent kinetic energy, C₁ and C₃ are model constants, σₖ and σ_{ε} are turbulent Prandtl numbers of k and ε, respectively, Qₖ represent the generation of turbulent kinetic energy caused by an average flow velocity gradient, and Pₖ: represents turbulent kinetic energy generated by buoyancy;
the streamline diagram and the flow velocity distribution diagram of the water flow in a river course are simulated based on the streamline equation and the flow velocity distribution equation of the water flow, and the average flow velocity and flow velocity distribution of the water flow in the river course are analyzed based on the streamline diagram of the water flow and the flow velocity distribution diagram;
establishing a constraint range for the average flow velocity: [vₘᵢₙ, vₘₐₓ], constraint conditions on the flow velocity distribution: uniformity of distribution, where, vₘᵢₙ is the minimum value allowed by a given average flow velocity, and vₘₐₓ, is the maximum value allowed by a given average flow velocity; and
when the average flow velocity obtained through analysis fails to fall within the constraint range and/or the flow velocity distribution fails to meet the constraint conditions, rectification measures need to be adopted.

5. The layout method of large-flux algae control wells based on a sluice-pump hub area according to claim 1, wherein the hydraulic characteristic values at least comprise: the flow velocity distribution uniformity and the velocity weighted average angle at the characteristic section of the pumping station units;
the flow velocity distribution uniformity is obtained by the following formula:
$${\overline{V}}_{u} = [ 1 - \frac{1}{\overline{{u}_{a}}} \sqrt{\frac{{Σ ( {u}_{ah} - \overline{{u}_{a}} )}^{2}}{m}} ] ⨯ 100 \% ;$$
the velocity weighted average angle is obtained by the following formula:
$$\overline{θ} = \frac{Σ {u}_{ah} [ 90 ° - arc tan \frac{{u}_{th}}{{u}_{ah}} ]}{Σ {u}_{at}} ;$$
in the formula, h is the number of the pumping station units, uₐₕ is the axial water flow velocity of the pumping station unit numbered h, uₜₕ is the transversal water flow velocity of the pumping station unit numbered h, and u̅ₐ̅ represents the average axial water flow velocity of h pumping station units;
the velocity distribution uniformity threshold V̅ᵤ̅ and the velocity weighted average angle threshold θ̅ are preset, and when the V̅ᵤ̅ <V̅ᵤ̅ and/or θ̅<θ̅, through calculation, it is necessary to adopt the rectification measures.

6. The layout method of large-flux algae control wells based on a sluice-pump hub area according to claim 5, wherein the method for intercepting a characteristic section is as follows:
selecting an inlet of the water inlet flow channel of each pumping station unit, and intercepting a vertical section obtained by the outlet of the water inlet flow channel in a vertical plane to obtain a characteristic section.

7. The layout method of large-flux algae control wells based on a sluice-pump hub area according to claim 2, wherein the process of obtaining the optimal number of grids is as follows:
subdividing grids of the river diversion channel, algae control wells, and pumping station units, performing local encryption processing on areas with complex structures, improving the quality of local grids by adjusting control points on the grids and adding topology layers, and controlling the dimensionless value within 100;
the total hydraulic loss is used as a basis to measure the influence of the number of grids on numerical calculation result, and the total hydraulic loss is calculated by the following formula:
$${H}_{f} = \frac{( {P}_{i n} - {P}_{out} )}{ρ g} ;$$
in the formula, H_{f} is the total hydraulic loss of the whole flow channel; Pᵢₙ and Pₒᵤₜ are the total pressure of the inlet and outlet of the inlet pool, respectively, and g is gravity acceleration; and
the analysis of grid independence indicates that the variation of hydraulic loss is small when the total number of grids is 12 million, and the grid quality reaches more than 0.3, meeting the numerical calculation requirements.

8. The layout method of large-flux algae control wells based on a sluice-pump hub area according to claim 3, wherein the bottom sill comprises: one or more of a forebay bottom sill and a bottom sill in the river diversion channel.

9. The layout method of large-flux algae control wells based on a sluice-pump hub area according to claim 1, wherein the retaining wall has a first wall surface and a second wall surface, the first wall surface and the second wall surface are perpendicular to each other, and the algae control wells are arranged in the first wall surface and the second wall surface at a predetermined interval.

10. The layout method of large-flux algae control wells based on a sluice-pump hub area according to claim 1, wherein the retaining wall has an arc-shaped wall surface and a second wall surface, and the arc-shaped wall surfaces are arranged opposite to the sluice-pump hub; and
the algae control wells are arranged in the arc-shaped wall surface at a predetermined interval.
